(19) United States
(12) Patent Application Publication
(10) Pub. No.: US 2013/0179614 A1
(43) Pub. Date: Jul. 11, 2013

(54) Command Abort to Reduce Latency in Flash Memory Access

(71) Applicants: Diarmuid P. Ross, Mountain View, CA (US); Douglas C. Lee, Cupertino, CA (US)

(72) Inventors: Diarmuid P. Ross, Mountain View, CA (US); Douglas C. Lee, Cupertino, CA (US)

(21) Appl. No.: 13/347,119

(22) Filed: Jan. 10, 2012

(51) Int. Cl. G06F 13/26

(52) U.S. Cl. 710/264

(57) ABSTRACT

In an embodiment, a peripheral component may include a command queue configured to store a set of commands to perform a transfer on a peripheral interface. Some of the commands may be long-latency commands, and the long-latency commands may be aborted to perform higher priority commands. In an embodiment, each command may have an abort attribute assigned by software which indicates whether or not the command is abortable. If a higher priority command needs to be performed while the long-latency command is in progress, the command may be aborted. In an embodiment, software may write an abort field in a control register to cause the long-latency command to be aborted.

### BACKGROUND

1. Field of the Invention

This invention is related to the field of integrated circuits and, more particularly, to command processing in a peripheral component in an integrated circuit.

2. Description of the Related Art

In a peripheral interface controller that has significant data bandwidth, one of the challenges that can occur is providing the control input to the peripheral interface controller from an external processor. Typically, the same internal interface to the peripheral controller that transfers data between the peripheral interface controller and memory is used to provide the control input from the external processor (e.g. via a series of writes to control registers in the peripheral interface controller). While the data transfers are occurring, the memory to peripheral interface can be saturated with the data transfers. Accordingly, control inputs to arrange for the next set of data transfers can be effectively locked out until the current data transfers complete. During the time that the control inputs are being provided, the external peripheral interface controlled by the peripheral interface controller can be idle.

One mechanism for reducing the contention on the peripheral to memory interface is to include a processor in the peripheral interface controller, executing a program to control the peripheral interface controller hardware. However, such a mechanism is expensive in a number of ways: in monetary terms to acquire the processor (either as a discrete component or as intellectual property that can be incorporated into the peripheral interface controller design); in terms of space occupied by the peripheral interface controller when the processor is included; and in terms of power consumed by the processor. Additionally, the program to be executed is stored in the system memory, and thus instruction fetches can compete with the data transfers on the peripheral to memory interface.

Additionally, it is complicated to interrupt one data transfer to perform another one, in the case that a need to perform a more important (or higher priority) data transfer is identified after a given data transfer is started.

### SUMMARY

In an embodiment, an integrated circuit includes a peripheral component configured to control an external interface of the integrated circuit. For example, the peripheral component may be a memory interface unit such as a flash memory interface unit. The internal interface to the peripheral component may be shared between data transfers to/from the external interface and control communications to the peripheral component. The peripheral component may include a command queue configured to store a set of commands to perform a transfer on the interface. Some of the commands may be long-latency commands, and the long-latency commands may be aborted to perform higher priority commands. In an embodiment, each command may have an abort attribute assigned by software which indicates whether or not the command is abortable. If a higher priority command needs to be performed while the long-latency command is in progress, the command may be aborted. In an embodiment, software may write an abort field in a control register to cause the long-latency command to be aborted.

Additionally, in an embodiment, the peripheral component may include a high priority command queue configured to store a second set of commands to perform a transfer on the interface. The high priority queue may be loaded with high priority commands, and a long-latency command in the low priority queue may be aborted to perform the high priority commands. In another embodiment, a direct execution register may be provided, which may be programmed with the command to be executed when the long-latency command is aborted.

The commands in the low priority command queue (described above) may include yield indications in addition to the abort indications. The yield indications identify points at which the set of commands may be interrupted to perform the second set of commands. A control circuit may be coupled to the low priority command queue and may read the commands and communicate with an interface controller to cause a transfer on the interface responsive to the commands. Additionally, the control circuit may interrupt the processing of the commands from the low priority queue responsive to the indications, and may process commands from the high priority command queue. The interruptions may occur after the completions of the commands. In an embodiment, the high priority queue may thus be used for either interruptions of the low priority queue or aborts of long-latency commands in the low priority queue.

In an embodiment, the ability to abort long-latency commands may lead to improved performance because high priority commands may be completed more quickly. The aborted command may remain in the low priority command queue and may be restarted after the high priority command(s) complete.

### BRIEF DESCRIPTION OF THE DRAWINGS

The following detailed description makes reference to the accompanying drawings, which are now briefly described.

FIG. 1 is a block diagram of one embodiment of an integrated circuit, a memory, and a flash memory.

FIG. 2 is a block diagram of one embodiment of a flash memory interface illustrated in FIG. 1.

FIG. 3 is a block diagram of another embodiment of the flash memory interface illustrated in FIG. 1.

FIG. 4 is a flowchart illustrating operation of one embodiment of a flash memory interface control circuit illustrated in FIG. 2 or 3 in response to receiving a write operation.

FIG. 5 is a table illustrating one embodiment of commands supported by the flash memory interface control circuit.

FIG. 6 is a flowchart illustrating operation of one embodiment of the flash memory interface control circuit shown in FIG. 2 or 3 in response to reading a command from a low priority command first-in, first-out buffer (FIFO).

FIG. 7 is a flowchart illustrating operation of one embodiment of the flash memory interface control circuit shown in FIG. 2 or 3 in response to reading a command from a high priority command first-in, first-out buffer (FIFO).

FIG. 8 is a block diagram of an example use of a macro memory.

FIG. 9 is a flowchart illustrating operation of one embodiment of flash memory interface code executed by one embodiment of a processor shown in FIG. 1.

FIG. 10 is a block diagram of one embodiment of a system including the apparatus illustrated in FIG. 1.

FIG. 11 is a block diagram of one embodiment of a computer accessible storage medium.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims. The headings used herein are for organizational purposes only and are not meant to be used to limit the scope of the description. As used throughout this application, the word “may” is used in a permissive sense (i.e., meaning having the potential to), rather than the mandatory sense (i.e., meaning must). Similarly, the words “include”, “including”, and “includes” mean including, but not limited to.

Various units, circuits, or other components may be described as “configured to” perform a task or tasks. In such contexts, “configured to” is a broad recitation of structure generally meaning “having circuitry that” performs the task or tasks during operation. As such, the unit/circuit/component can be configured to perform the task even when the unit/circuit/component is not currently on. In general, the circuitry that forms the structure corresponding to “configured to” may include hardware circuits and/or memory storing program instructions executable to implement the operation. The memory can include volatile memory such as static or dynamic random access memory and/or nonvolatile memory such as optical or magnetic disk storage, flash memory, programmable read-only memories, etc. Similarly, various units/circuits/components may be described as performing a task or tasks, for convenience in the description. Such descriptions should be interpreted as including the phrase “configured to.” Reciting a unit/circuit/component that is configured to perform one or more tasks is expressly intended not to invoke 35 U.S.C. §112, paragraph six interpretation for that unit/circuit/component.

### DETAILED DESCRIPTION OF EMBODIMENTS

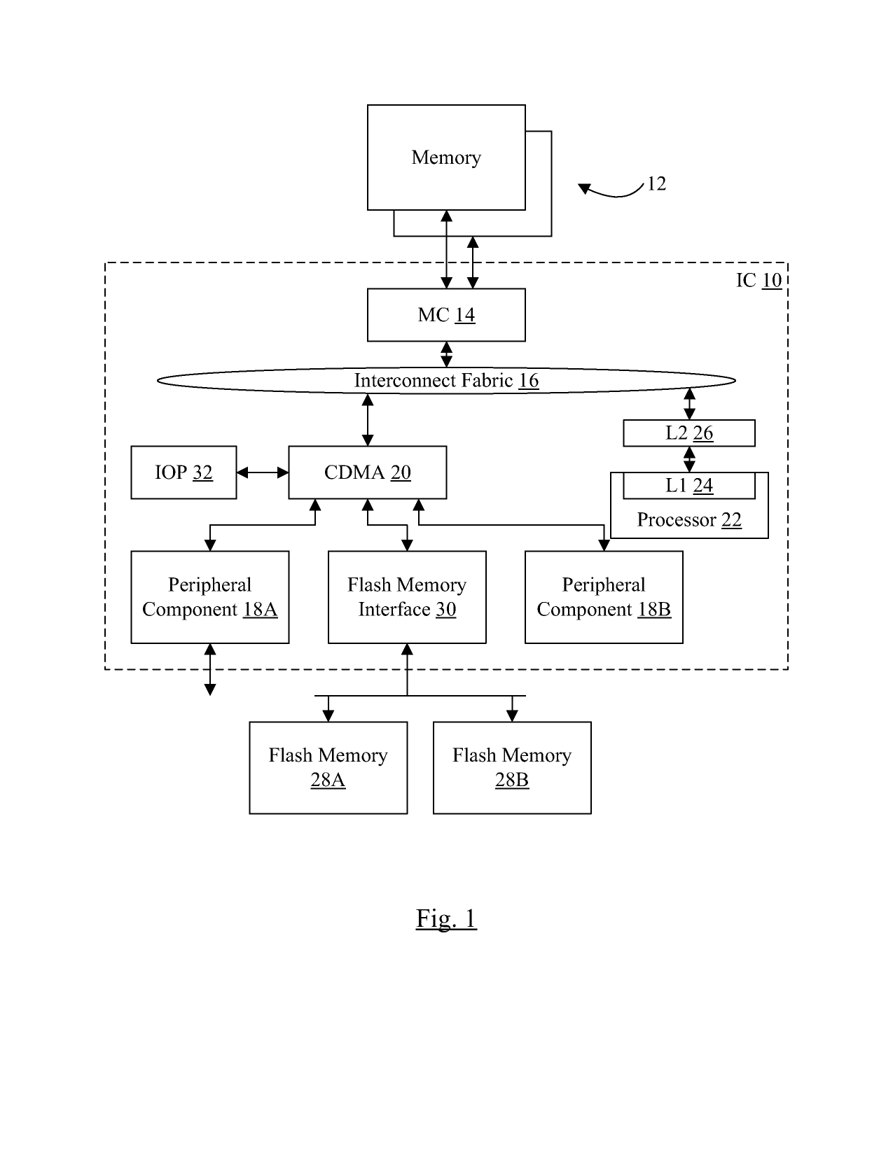

Turning now to FIG. 1, a block diagram of one embodiment of an integrated circuit 10 coupled to an external memory 12 and one or more flash memory devices 28A-28B is shown. In the illustrated embodiment, the integrated circuit 10 includes a memory controller 14, an interconnect fabric 16, a set of peripheral components such as components 18A-18B, a flash memory interface unit 30, a central DMA (CDMA) controller 20, a processor 22 including a level 1 (L1) cache 24, a level 2 (L2) cache 26, and an input/output (I/O) processor (IOP) 32. The memory controller 14 is coupled to a memory interface to which the memory 12 may be coupled, and is coupled to the interconnect fabric 16. The CDMA controller 20, the L2 cache 26, and the processor 22 (through the L2 cache 26) are also coupled to the interconnect fabric 16 in the illustrated embodiment. The L2 cache 26 is coupled to the processor 22, and the CDMA controller 20 is coupled to the components 18A-18B, the flash memory interface unit 30, and the IOP 32. One or more peripheral components 18A-18B may be coupled to external interfaces as well, such as the peripheral component 18A. In other embodiments, other components may be coupled to the interconnect fabric 16 directly (e.g. other peripheral components).

The CDMA controller 20 may be configured to perform DMA operations between the memory 12, various peripheral components 18A-18B, and/or the flash memory interface unit 30. Various embodiments may include any number of peripheral components and/or flash memory interface units 30 coupled to the CDMA controller 20. The processor 22 (and more particularly, instructions executed by the processor 22) may program the CDMA controller 20 to perform DMA operations. Various embodiments may program the CDMA controller 20 in various ways. For example, DMA descriptors may be written to the memory 12, describing the DMA operations to be performed, and the CDMA controller 20 may include registers that are programmable to locate the DMA descriptors in the memory 12. Multiple descriptors may be created for a DMA channel, and the DMA operations described in the descriptors may be performed as specified. Alternatively, the CDMA controller 20 may include registers that are programmable to describe the DMA operations to be performed, and programming the CDMA controller 20 may include writing the registers.

Generally, a DMA operation may be a transfer of data from a source to a target that is performed by hardware separate from a processor that executes instructions. The hardware may be programmed using instructions executed by the processor, but the transfer itself is performed by the hardware independent of instruction execution in the processor. At least one of the source and target may be a memory. The memory may be the system memory (e.g. the memory 12), the flash memory devices 28A-28B, or may be an internal memory in the integrated circuit 10, in some embodiments. Some DMA operations may have memory as a source and a target (e.g. a DMA operation between the memory 12 and the flash memory devices 28A-28B, or a copy operation from one block of the memory 12 to another). Other DMA operations may have a peripheral component as a source or target. The peripheral component may be coupled to an external interface on which the DMA data is to be transferred or on which the DMA data is to be received. For example, the peripheral component 18A may be coupled to an interface onto which DMA data is to be transferred or on which the DMA data is to be received. Thus, a DMA operation may include the CDMA controller 20 reading data from the source and writing data to the destination. The data may flow through the CDMA controller 20 as part of the DMA operation. Particularly, DMA data for a DMA read from the memory 12 may flow through the memory controller 14, over the interconnect fabric 16, through the CDMA controller 20, to the peripheral component 18A-18B or the flash memory interface unit 30 (and possibly on the interface to which the peripheral component is coupled, if applicable). Data for a DMA write to memory may flow in the opposite direction.

In one embodiment, instructions executed by the processor 22 and/or the IOP 32 may also communicate with the peripheral components 18A-18B and the flash memory interface unit 30 using read and/or write operations referred to as programmed input/output (PIO) operations. The PIO operations may have an address that is mapped by the integrated circuit 10 to a peripheral component 18A-18B or the flash memory interface unit 30 (and more particularly, to a register or other readable/writeable resource in the component). The address mapping may be fixed in the address space, or may be programmable. Alternatively, the PIO operation may be transmitted in a fashion that is distinguishable from memory read/write operations (e.g. using a different command encoding than memory read/write operations on the interconnect fabric 16, using a sideband signal or control signal to indicate memory vs. PIO, etc.). The PIO transmission may still include the address, which may identify the peripheral component 18A-18B or the flash memory interface unit 30 (and the addressed resource) within a PIO address space, for such implementations. The addressed resource may be any resource within the addressed component/unit, such as a configuration or control register, a logical resource (e.g. the PIO may be interpreted as a command), etc.

In one embodiment, PIO operations may use the same interconnect as the CDMA controller 20, and may flow through the CDMA controller 20, for peripheral components 18A-18B and the flash memory interface unit 30. Thus, a PIO operation may be issued by the processor 22 onto the interconnect fabric 16 (through the L2 cache 26, in this embodiment), to the CDMA controller 20, and to the targeted peripheral component/flash memory interface unit. Similarly, the IOP 32 may issue PIO operations to the CDMA controller 20, which may transmit the PIO operation over the same interconnect to the peripheral components 18A-18B or the flash memory interface unit 30.

Accordingly, data transfers for a DMA operation to/from a peripheral component 18A-18B or the flash memory interface unit 30 may conflict with PIO operations to/from the same peripheral component 18A-18B or the flash memory interface unit 30. For example, the flash memory interface unit 30 may be programmed via PIO operations to perform memory transfers to/from the flash memory devices 28A-28B. For write operations, the CDMA controller 20 may DMA the data to be written to the flash memory interface unit 30. For read operations, the CDMA controller 20 may DMA the data to be read from the flash memory interface unit 30. In an embodiment, flash memory devices 28A-28D may support a page of data transfer to/from the devices. The size of the page is device-dependent, and may not be the same as the page size used for virtual-to-physical address translation for the memory 12. For example, page sizes of 512 bytes, 2048 bytes, and 4096 bytes are often used. Accordingly, a page may be the unit of transfer of data for the memory device, in this context.

The flash memory interface unit 30 may be programmed to perform a page of data transfer, and the CDMA unit 20 may perform the DMA operations to transfer the data. If multiple pages are to be transferred, additional PIO operations may be used to program the flash memory interface unit 30 to perform the next transfer. However, the DMA operations may effectively lock out the additional PIO operations until the current page completes. Thus, the time elapsing while programming the flash memory interface unit 30 for the next page may result in idle time on the interface to the flash memory devices.

Additionally, a DMA transfer may be initiated, and then a higher priority data transfer or other command may be needed in the IC 10. For example, with regard to the flash memory interface unit 30, the on-going DMA transfer may be initiated by an application, and then the operating system may need to page out data to the flash memory 28A-28B or read data from the flash memory 28A-28B to satisfy a page fault. Alternatively, an application that is executing in the background may have started a DMA transfer, and an actively-used (foreground) application may need to perform a transfer. In another example, applications may be assigned priorities. In yet another example, hardware in the IC 10 may require access to the flash memory 28A-28B and may be higher priority than software access.

In one embodiment, the flash memory interface unit 30 may support an abort of at least some commands (e.g. long-latency commands) to perform a high priority command. Aborting a command may refer to terminating a command that is in-progress (that is, processing of the command has been initiated within the flash memory interface unit 30) but that has not completed. The abort may include terminating the command internally and, to the extent that the command includes communication on the interface to the flash memory devices 28A-28B, properly terminating the communication on the interface according to the protocol on the interface. An aborted command may need to be restarted from the beginning after the higher priority command(s) is(are) completed in response to the abort. On the other hand, the flash memory interface unit 30 may support interrupting a command sequence between commands (e.g. the interrupt may occur upon completion of an in-progress command). Shorter latency commands may be interrupted rather than aborted.

In one embodiment, the flash memory interface unit 30 may support a command queue into which the commands to perform a transfer may be programmed. An abort request may be supported via a control register having an abort field. The processor 22 may write the abort field via a PIO transaction to request the abort. If an in-progress command is abortable, the flash memory interface unit may be configured to abort the command to perform a high priority command. If the in-progress command is not abortable, the commands may be interrupted after completion of the in-progress command. In an embodiment, a subset of the commands may be defined as long-latency commands that are abortable. In another embodiment, the subset of commands may be programmable. Particularly, each entry in the command queue, in an embodiment, may include an abort indication identifying the command stored in that entry as abortable or not abortable. In such an embodiment, different instances of a given command may be defined as abortable or non-abortable. The different instances of the command may be stored in different entries of the command queue and may be in different locations with a command sequence (or in different sequences). Defining a subset of abortable commands and providing the abort indication for the subset may be implemented together in an embodiment. That is, a subset of the commands may be defined to be abortable, and abort indications may be provided with instances of the subset of commands to indicate abortable (or not) for each instance. Alternatively, any command in the command set may be programmed as abortable or non-abortable using the abort indication, in another embodiment.

In one embodiment, the flash memory interface unit 30 may support multiple command queues. Commands to program the flash memory interface unit 30 for a set of pages to be transferred may be queued in one of the command queues. Once the DMA operations for the first page begin, the data to program the flash memory interface unit 30 for subsequent pages may already be stored in the command queue. Accordingly, there may be no conflict between the PIO operations to program the flash memory interface unit 30 and the DMA operations to transfer the data. The utilization on the interface to the flash memory devices 28A-28B may be increased due to the ability to process the commands from the command queue to configure the flash memory controller 30 for the next page to be transferred while the CDMA unit 30 completes the DMA operations for the current page.

Furthermore, the command queues may have a priority associated with them. For example, two queues may be included: One may be a low priority queue and the other may be a high priority queue. The flash memory interface unit 30 may be configured to interrupt processing of commands in the low priority queue if there are commands in the high priority queue to be processed. Thus, a higher-priority transfer may interrupt a lower-priority transfer. In one embodiment, the low priority queue may include one or more yield indications that identify locations in the command stream at which interruption is permissible. The indications may ensure that the interruption occurs at a “good” place in the commands (e.g. at the end of a page, at a synchronization point, etc.). That is, the operations that were occurring in the low priority queue at the time commands are written to the high priority queue may be completed, so that those operations do not need to be performed again after the high priority processing has finished. In one embodiment, the queues may be statically assigned as high priority or low priority. In other embodiments, the priority may be programmable. The yield indications may be in addition to the abort indications described above.

In an embodiment, the flash memory interface unit 30 may support a macro memory to store one or more macros. A macro may be a sequence of two or more commands that may be invoked via a macro command. For example, the macro command may be written to one of the command queues, and may invoke the macro when the macro command is performed by the flash memory interface unit 30. Macros that implement frequently-used sequences of commands may be downloaded to the macro memory, and thus fewer commands need be downloaded subsequently. That is, macro commands may be written to the command queue instead of repeatedly writing the commands that are stored in the macro. In one embodiment, the macro command may specify a starting address of the macro and a number of words in the macro. Once the number of words have been read from the macro and the corresponding commands have been performed, the next command in the corresponding command queue after the macro command may be performed. Accordingly, return commands may be avoided in the macro, permitting more dense macros in an embodiment. Other embodiments may use the starting address and a number of commands as operands. Still other embodiments may implement a return command and the macro command may include the starting address (but not word/command count) as an operand. In an embodiment, the macro command may also include a loop count operand. The loop count operand may specify a number of iterations of the macro that are to be performed. Thus, performing the macro command may include reading the number of words beginning at the starting address and performing the commands, iterated the loop count number of times, before proceeding with the next command in the command queue after the macro command.

Commands in the command queues and/or commands in the macro memory may use operands to control their operation. In some cases, the operands may be stored in the corresponding command queue. In other cases, the operands may be stored in an operand queue. Commands in the command queue or in the macro memory may specify that the flash memory interface unit 30 load operands from the operand queue and operate on the operands. The operand queue may be used with a macro to supply instance-specific data for the generic macro (e.g. flash memory addresses, chip enables, etc.). Similarly, the operand queue may supply operands for the commands in the command queue.

A memory transfer, as used herein, may refer to the transfer of data to/from a memory device (via the interface to the memory device). Thus, a memory transfer to/from the flash memory devices 28A-28B may occur over the interface between the flash memory devices 28A-28B and the flash memory interface unit 30. Similarly, a memory transfer to/from the memory 12 may occur over the interface between the memory 12 and the memory controller 14. The memory transfer may occur using a protocol defined by the memory devices. Additionally, a command may refer to one or more bytes of data that are interpreted by the hardware in the peripheral component (e.g. the flash memory interface unit 30) as specifying a particular operation to be performed by the hardware.

Generally, a peripheral component may be any desired circuitry to be included on the integrated circuit 10 with the processor. A peripheral component may have a defined functionality and interface by which other components of the integrated circuit 10 may communicate with the peripheral component. For example, peripheral components may include video components such as display controllers, graphics processors, etc.; audio components such as digital signal processors, mixers, etc.; networking components such as an Ethernet media access controller (MAC) or a wireless fidelity (WiFi) controller; controllers to communicate on various interfaces such as universal serial bus (USB), peripheral component interconnect (PCI) or its variants such as PCI express (PCIe), serial peripheral interface (SPI), flash memory interface, etc. The flash memory interface unit 30 may be one example of a peripheral component, and the general properties of a peripheral component described herein may be applicable to the flash memory interface unit 30.

The processor 22 may implement any instruction set architecture, and may be configured to execute instructions defined in that instruction set architecture. The processor 22 may employ any microarchitecture, including scalar, superscalar, pipelined, superpipelined, out of order, in order, speculative, non-speculative, etc., or combinations thereof. The processor 22 may include circuitry, and optionally may implement microcoding techniques. In the illustrated embodiment, the processor 22 may include an L1 cache 24 to store data and instructions for use by the processor 22. There may be separate L1 data and instruction caches. The L1 cache(s) may have any capacity and organization (set associative, direct mapped, etc.). In the illustrated embodiment, an L2 cache 26 is also provided. The L2 cache 26 may have any capacity and organization, similar to the L1 cache(s).

Similarly, the IOP 32 may implement any instruction set architecture, and may be configured to execute instructions defined in that instruction set architecture. The instruction set architecture implemented by the IOP 32 need not be the same instruction set architecture implemented by the processor 22. In one embodiment, the IOP 32 may be a lower power, lower performance processor than the processor 22. The IOP 32 may handle various I/O interface issues (configuring peripheral components to perform desired operations, certain error handling, etc.). The IOP 32 may execute instructions to write commands to the command queue in the flash memory interface unit 30, write macros to the macro memory in the flash memory interface unit 30, and/or write operands to the operand queue in the flash memory interface 30. The IOP 32 may further execute instructions to service other peripheral components 18A-18B. Thus, the processor 22 may perform other computing tasks, or many be powered down to conserve power if there are no other computing tasks to be performed. The IOP 32 may employ any microarchitecture, including scalar, superscalar, pipelined, superpipelined, out of order, in order, speculative, non-speculative, etc., or combinations thereof. The IOP 32 may include circuitry, and optionally may implement microcoding techniques.

The interconnect fabric 16 may be any interconnect over which the memory controller 14, the processor 22 (through the L2 cache 26), the L2 cache 26, and the CDMA controller 20 may communicate. The interconnect fabric 16 may implement any type of interconnect (e.g. a bus, a packet interface, point to point links, etc.). In one embodiment, the interconnect fabric 16 may be a hierarchy of interconnects. For example, the processor 22 and caches 24 and 26 may be implemented in a “core complex” that includes a coherence port and a port to the memory controller 14. The CDMA controller 20 may be coupled to the coherency port. In some embodiments, the memory controller 14 may be multi-ported. In some such embodiments, the CDMA controller 20 may be coupled to a separate port on the memory controller 14. In other such embodiments, the CDMA controller 20 may still be coupled through the ACP port.

The memory controller 14 may be configured to receive memory requests from the system interface unit 16. The memory controller 14 may be configured to access the memory 12 to complete the requests (writing received data to the memory 12 for a write request, or providing data from the memory 12 in response to a read request) using the interface defined for the attached memory 12. The memory controller 14 may be configured to interface with any type of memory 12, such as dynamic random access memory (DRAM), synchronous DRAM (SDRAM), double data rate (DDR, DDR2, DDR3, etc.) SDRAM, RAMBUS DRAM (RDRAM), static RAM (SRAM), etc. The memory may be arranged as multiple banks of memory, such as dual inline memory modules (DIMM5), single inline memory modules (SIMMs), etc. In one embodiment, one or more memory chips are attached to the integrated circuit 10 in a package on package (POP) or chip-on-chip (COC) configuration.

The memory 12 may include one or more memory devices. Generally, a memory device may be any component that is designed to store data according to an address provided with the data in a write operation, and to supply that data when the address is used in a read operation. Any of the examples of memory types mentioned above may be implemented in a memory device, and the flash memory devices 28A-28B may be memory devices as well. A memory device may be a chip, multiple chips connected to a substrate such as a printed circuit board (e.g. a SIMM or DIMM, or directly connected to a circuit board to which the IC 10 is coupled), etc.

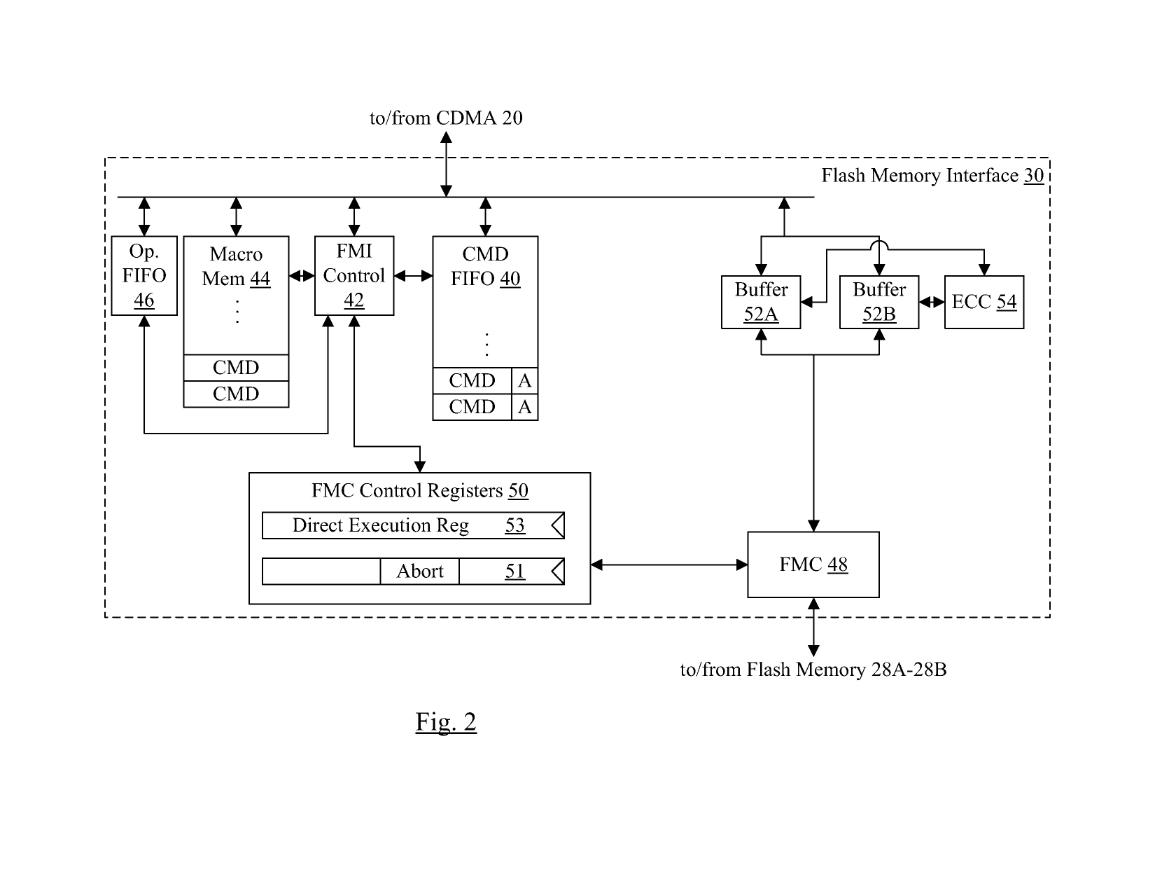

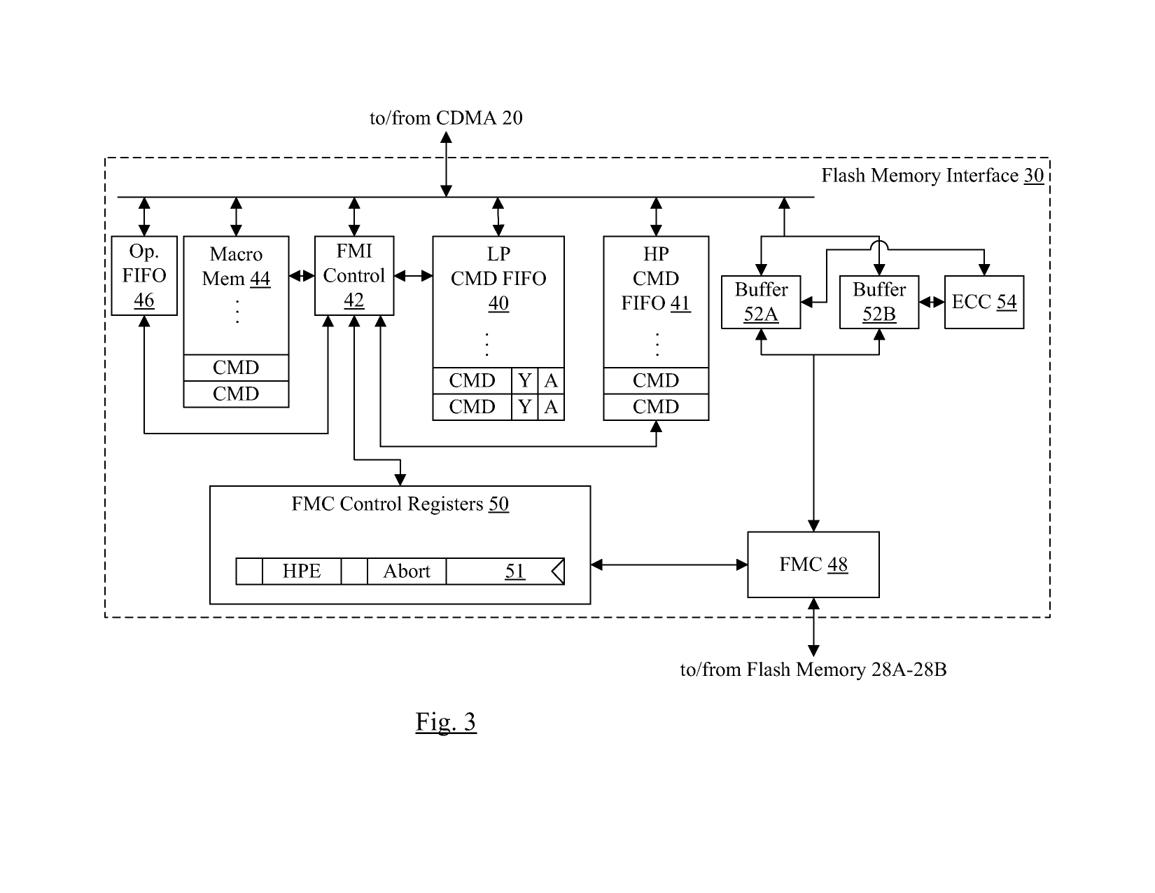

The flash memory interface unit 30 may include circuitry configured to receive read and write requests for the flash memory devices 28A-28B, and configured to interface to the flash memory devices 28A-28B to complete the read/write requests. In one embodiment, the read/write requests may be sourced from the CDMA controller 20. The flash memory interface unit 30 may be programmable via one or more control registers (see FIGS. 2 and 3 described below) to perform memory transfers to/from the flash memory devices 28A-28B (e.g. via PIO operations). Flash memory devices 28A-28B may be flash memory, a type of non-volatile memory that is known in the art. In other embodiments, other forms of non-volatile memory may be used. For example, battery-backed SRAM, various types of programmable ROMs such as electrically-erasable programmable ROMs (EEPROMs), etc. may be used. In still other embodiments, volatile memory may be used similar to memory 12.

While the present embodiment describes using the command queues (FIFOs), macro memory, and/or operand queue (FIFO) in the flash memory interface unit 30, other embodiments may implement the features in any peripheral component, with any type of memory or peripheral interface.

It is noted that other embodiments may include other combinations of components, including subsets or supersets of the components shown in FIG. 1 and/or other components. While one instance of a given component may be shown in FIG. 1, other embodiments may include one or more instances of the given component.

Turning now to FIG. 2, a block diagram of one embodiment of the flash memory interface unit 30 is shown. In the illustrated embodiment, the flash memory interface unit 30 includes a command FIFO 40, a flash memory interface (FMI) control circuit 42, a macro memory 44, an operand FIFO 46, a flash memory controller (FMC) 48, a set of FMC control registers 50 including registers 51 and 53, data buffers 52A-52B, and an error checking/correction (ECC) unit 54. The command FIFO 40, FMI control circuit 42, macro memory 44, operand FIFO 46, and buffers 52A-52B are all coupled to an internal interface to the CDMA controller 20. The FMI control circuit 42 is further coupled to the command FIFO 40, the macro memory 44, the operand FIFO 46, and the FMC control registers 50. The FMC control registers 50 are further coupled to the FMC 48, which is coupled to an external interface to the flash memory devices. The FMC 48 is further coupled to the buffers 52A-52B. The ECC unit 54 is also coupled to the buffers 52A-52B.

The FMI control circuit 42 may be configured to receive PIO operations from the CDMA controller 20. Some PIO operations may be directed to the command FIFO 40, the macro memory 44, or the operand FIFO 46. For example, PIO writes may be used to write commands into the command FIFO 40, to download macros into the macro memory 44, or to write operands into the operand FIFO 46. Addresses may be assigned to each of the FIFO 40, the macro memory 44, and the operand FIFO 46, which may be used in the PIO operands to address the desired resource. For example, the FIFOs 40 and 46 may have a single assigned address since they may operate in a first-in, first-out manner. A PIO write to the address may cause the FMI control circuit 42 to store the data provided with the write in the next open entry in the FIFOs 40 or 46. That is, the data may be appended to the tail of the FIFO 40 or 46, where commands or operands are removed from the head of the FIFO 40 or 46. The macro memory 44 may have a range of addresses assigned to it, e.g. an address per word of the macro memory 44. PIO writes to the addresses may store the provided data word into the addressed word of the macro memory 44.

The FMI control circuit 42 may process the commands in the command FIFO 40 to program various FMC control registers 50 to cause the FMC 48 to perform a particular memory transfer to/from the flash memory devices 28A-28B. In one embodiment, the FMC 48 is configured to receive relatively low-level control via the FMC control registers 50, including address, chip enables, transfer commands, etc. Commands in the command FIFO 40 may be interpreted by the FMI control circuit 42 and the corresponding FMC control registers 50 may be written by the FMI control circuit 42. Similarly, commands to wait for an event may be interpreted by the FMI control circuit 42 to read one or more FMC control registers 50 to detect the event. There may also be direct control signals between the FMI control circuit 42 to the FMC 48, in some embodiments (not shown in FIG. 2) which may be driven by the FMI control circuit 42 responsive to commands and/or monitored by the FMI control circuit 42 responsive to commands.

The FMI control circuit 42 may be configured to read the commands from the command FIFO 40 in the order written to that FIFO. More generally, a command queue may be supported (e.g. the command FIFO 40 may not be specifically constructed as a FIFO, such that each entry in the queues may be concurrently visible to the FMI control circuit 42). Similarly, the operand FIFO 46 may be an operand queue, and the FMI control circuit 42 may read operands from the operand FIFO 46 responsive to the commands in the command queue or the macro memory 44 in the order the operands were written.

If commands are written to the command FIFO 40, the FMI control circuit 42 may read commands from the command FIFO 40 and perform the commands. Each entry in the command FIFO 40 includes an abort indication (A). For example, the abort indication may be a bit which may be set to indicate that the corresponding command is abortable and clear to indicate that the corresponding command is not abortable. Other embodiments may use the opposite meanings for the set and clear states of the bit, or may use multi-bit indications.

The control register 51 includes an abort field, which may be written via a PIO operation to request an abort for high priority command processing. The abort field may also be a bit, in an embodiment, with the set state indicating an abort request and the clear state indicating no abort request. Other embodiments may use the opposite meanings for the set and clear states or multi-bit indications. Responsive to the abort request and the abort indication in the command FIFO 40 corresponding to the in-progress command indicating abortable, the FMI control circuit 42 may abort processing of the in-progress command to process the high priority command(s). If the abort indication indicates non-abortable, the in-progress command may be completed and the command sequence in the command FIFO 40 may be interrupted to process the high priority command(s).

In the illustrated embodiment, a control register 53 is provided to store a high priority command. The register 53 is illustrated as a direct execution register, because commands may be written to the register 53 to be directly processed by the FMI control circuit 42 rather than queuing them in the command FIFO 40. Accordingly, to process a high priority command in this embodiment, the processor 22 may write the high priority command to the direct execution register 53 and then write the abort field in the register 51. Other embodiments may include more than one direct execution register 53, to permit more than one high priority command to be queued.

As mentioned previously, a macro command may be in the command FIFO 40, and the FMI control circuit 42 may perform commands from the macro memory 44 in response to the macro command. In other embodiments, the macro command may be transmitted as a PIO operation to the FMI control circuit 42. In still other embodiments, macro commands may be encountered in the command FIFO 40 or in PIO operations, or in the direct execution register 53. The macro command may include a starting address in the macro memory and a word count indicating the number of words to read from the macro memory 44. The FMI control circuit 42 may perform the commands in the macro prior to reading the next command (following the macro command) in the command FIFO 40. The words in the macro may include operands in addition to commands, in one embodiment. Other embodiments may use a command count rather than a word count. As mentioned above, the macro command may also include a loop count and the macro may be iterated the number of times indicated by the loop count.

Reading words from the command FIFO 40 and from the operand FIFO 46 may include the FMI control circuit 42 deleting those words from the FIFO. However, at least in the case of abortable commands, the words may not be deleted until the abortable commands complete. Thus, if a given abortable command is aborted, the command remains in the FIFO 40 to be processed after the high priority commands. Reading words from the macro memory 44, on the other hand, may not involve deleting the words so that macros may be repeatedly performed.

The FMC 48 may perform memory transfers in response to the contents of the FMC control registers 50, writing data read from the flash memory devices 28A-28B to the buffers 52A-52B or writing data read from the buffers 52A-52B to the flash memory devices 28A-28B. The buffers 52A-52B may be used in a ping-pong fashion, in which one of the buffers 52A-52B is being filled with data while the other is being drained. For example, reads from the flash memory devices 28A-28B may include the FMC 48 filling one of the buffers 52A-52B while the other buffer 52A-52B is being drained by the CDMA controller 20 performing DMA operations to memory 12. Writes to the flash memory devices 28A-28B may include the CDMA controller 20 filling one of the buffers 52A-52B with data while the FMC 48 drains the other buffer 52A-52B. The ECC unit 54 may generate ECC data for writes to the flash memory devices 28A-28B, and may check the ECC data for reads from the flash memory devices 28A-28B.

In another embodiment, the flash memory interface unit 30 may include multiple queues (FIFOs) for commands. FIG. 3 is an example of such an embodiment. The embodiment of FIG. 3 is similar to the embodiment of FIG. 2 except the FIFO 40 is now a low priority (LP) command FIFO and a high priority (HP) command FIFO 41 is also included. The HP command FIFO 41 is coupled to the interface to the CDMA unit 20 and to the FMI control circuit 42. The HP command FIFO 41 may include multiple entries that store commands, and may generally operate in a fashion similar to the command FIFO 40. However, the FMI control circuit 42 may treat commands in the HP command FIFO 41 as higher priority than the commands in the LP command FIFO 40. Thus, the HP command FIFO 41 may be loaded with high priority commands to be processed after aborting an abortable command in the LP command FIFO 40, or interrupting between commands in the LP command FIFO 40. Other embodiments may include the direct execution register 53 as well, and either the register 53 or the FIFO 41 may be used. In another embodiment, the high priority command FIFO 41 may include abort indications to permit an abort to process an even higher priority command.

If commands are written to the HP FIFO 41 while the FMI control circuit 42 is processing commands from the LP command FIFO 40, the FMI control circuit 42 may be configured to abort an in-process command (if the abort indication indicates abortable). If the abort indication does not indicate abortable, the FMI control circuit 42 may determine a point at which to interrupt processing of the commands from the FIFO 40 to begin processing the commands from the FIFO 41 (or may abort at the next command that is indicated as abortable, if any). In FIG. 3, several entries in the LP command FIFO 40 are illustrated for this embodiment. In this embodiment, each entry in the LP command FIFO 40 may include storage for the command and the abort indication, along with a yield indication (e.g. a bit “Y”). If the yield bit is set for a given command, the processing of commands may be interrupted after the given command is processed. If the yield bit is clear, processing may not be interrupted. The yield bits may be part of the PIO data for PIO writes to the LP command FIFO 40. In other embodiments, other indications may be used (e.g. a bit with the opposite meanings for the set and clear states, multibit values, etc.). Furthermore, other embodiments may use a separate command in the FIFO 40 to indicate interruptibility. That is, a command may be defined whose operation is to permit the FMI control circuit 40 to interrupt processing from the FIFO 40 to process commands from the FIFO 41, if there are such commands. If no commands are awaiting processing in the FIFO 41, processing in the FIFO 40 may continue with the next command.

In response to aborting or interrupting the commands in the LP command FIFO 40 to process commands in the HP command FIFO 41, the FMI control circuit 42 may be configured to update an HPE field in the register 51. For example, the HPE field may be a bit and the FMI control circuit 42 may be configured to set the HPE bit in this embodiment. Other embodiments may reverse the meanings of set and clear states of the HPE bit, or may use a multi-bit HPE field. Once the HPE bit is set, the FMI control circuit 42 may be configured to process commands from the HP command FIFO 41, if any, but may not process commands from the LP command FIFO 40 until the HPE bit is cleared. The FMI control circuit 42 may not clear the HPE bit, but rather software may do so by writing the register 51. In this fashion, if the FMI control circuit 42 empties the HP command FIFO 41 before software finishes filling the command FIFO 41 (e.g. due to interruption of the software, delays in transmitting the commands to the flash memory interface unit 30, etc.), the FMI control circuit 42 may not prematurely return to processing commands from the LP command FIFO 40. Additionally, once the high priority sequence of commands is completed, software may read the LP command FIFO 40 to determine where the lower priority sequence of commands was interrupted. In some embodiments, the HPE filed may be included in a different control register than the abort field.

In some embodiments, software may also write the register 51 to set the HPE bit. Doing so may cause the FMI control circuit 42 to interrupt processing of the LP command FIFO 40 at the next boundary (as indicated by the Y bits). Such operation may permit software to stop the processing of the LP command FIFO 40 and may permit software to examine the status of the LP command FIFO 40. Similarly, software may write a wait command (or other command that causes no change to the configuration of the flash memory interface 30 or the control registers 50) to the HP command FIFO 41, which may cause the FMI control circuit 42 to interrupt the processing of commands from the LP command FIFO 40 at an appropriate point. In other embodiments, the HPE and abort fields may be implemented in different registers within the FMC control registers 50.

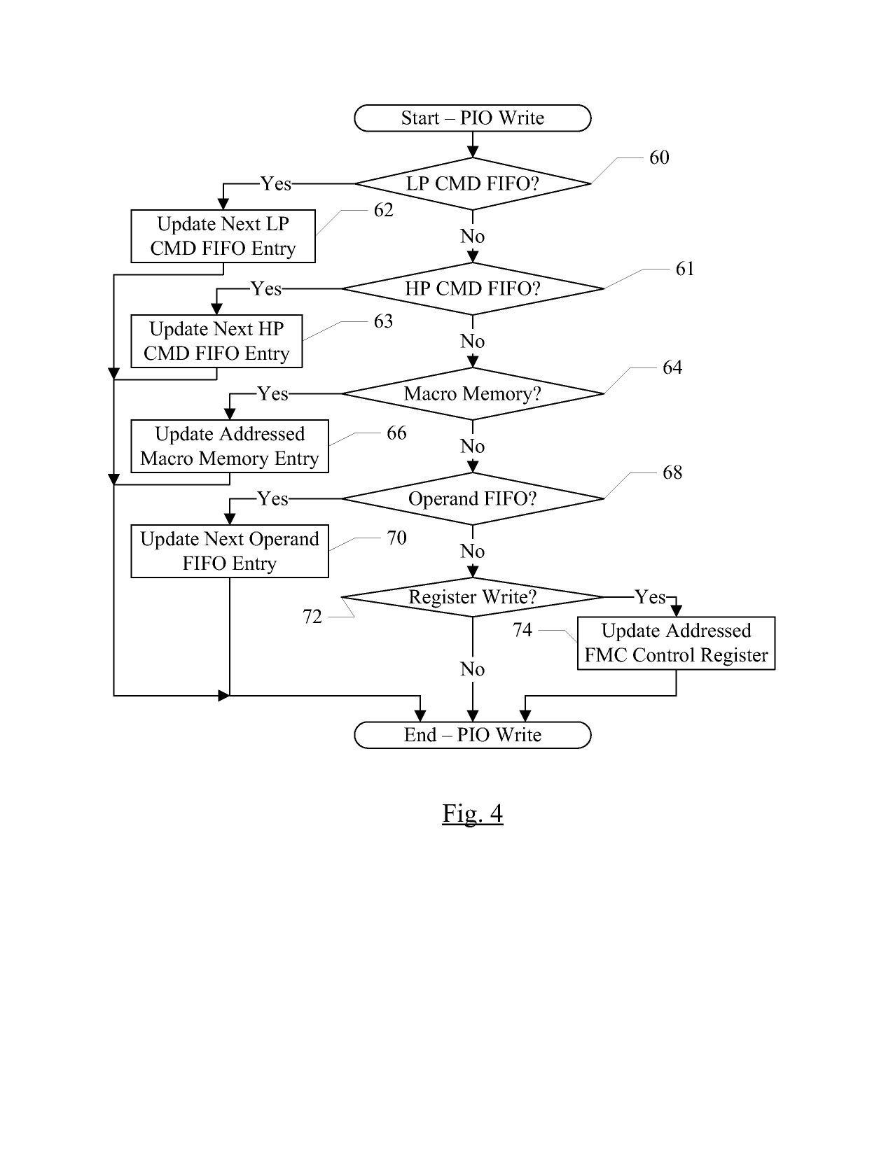

Turning now to FIG. 4, a flowchart is shown illustrating operation of one embodiment of the FMI control circuit 42 in response to receiving a PIO operation from the CDMA controller 20. While the blocks are shown in a particular order for ease of understanding, other orders may be used. Blocks may be performed in parallel in combinatorial logic in the FMI control circuit 42. For example, the decision blocks illustrated in FIG. 4 may be independent and may be performed in parallel. Blocks, combinations of blocks, and/or the flowchart as a whole may be pipelined over multiple clock cycles. The FMI control circuit 42 may be configured to implement the operation illustrated in FIG. 4. The illustrated embodiment may apply to the embodiment of FIG. 3. A similar flowchart may apply to the embodiment of FIG. 2, except that there may be only one command FIFO to be updated rather than the LP command FIFO 40 and the HP command FIFO 41 as shown in FIG. 4.

If the PIO write is addressed to the LP command FIFO 40 (decision block 60, “yes” leg), the FMI control circuit 42 may be configured to update the next entry in the LP command FIFO 40 with the data from the PIO write (block 62). That is, the data from the PIO write may be appended to the tail of the LP command FIFO 40. As mentioned above, the PIO data in this embodiment may be the command, the abort bit, and the yield bit. If the PIO write is addressed to the HP command FIFO 41 (decision block 61, “yes” leg), the FMI control circuit 42 may be configured to update the next entry in the HP command FIFO 41 with the data from the PIO write (block 63). That is, the data from the PIO write may be appended to the tail of the HP command FIFO 41. As mentioned above, the PIO data in this embodiment may be the command. If the PIO write is addressed to the macro memory 44 (decision block 64, “yes” leg), the FMI control circuit 42 may be configured to update the addressed entry in the macro memory 44 with the data from the PIO write (block 66). If the PIO write is addressed to the operand FIFO 46 (decision block 68, “yes” leg), the FMI control circuit 42 may be configured to update the next entry in the operand FIFO 46 with the data from the PIO write (block 70). That is, the data from the PIO write may be appended to the tail of the operand FIFO 46. If the PIO write is addressed to a register within the FMC control registers 50 (or other registers in the flash memory interface unit 30, in various embodiments—decision block 72, “yes” leg), the FMI control circuit 42 may be configured to update the addresses register (block 74). For example, the PIO may be addressed to the register 51 to write the abort field and/or the HPE field, or may be address to the register 53 to write a high priority command to the direct execution register.

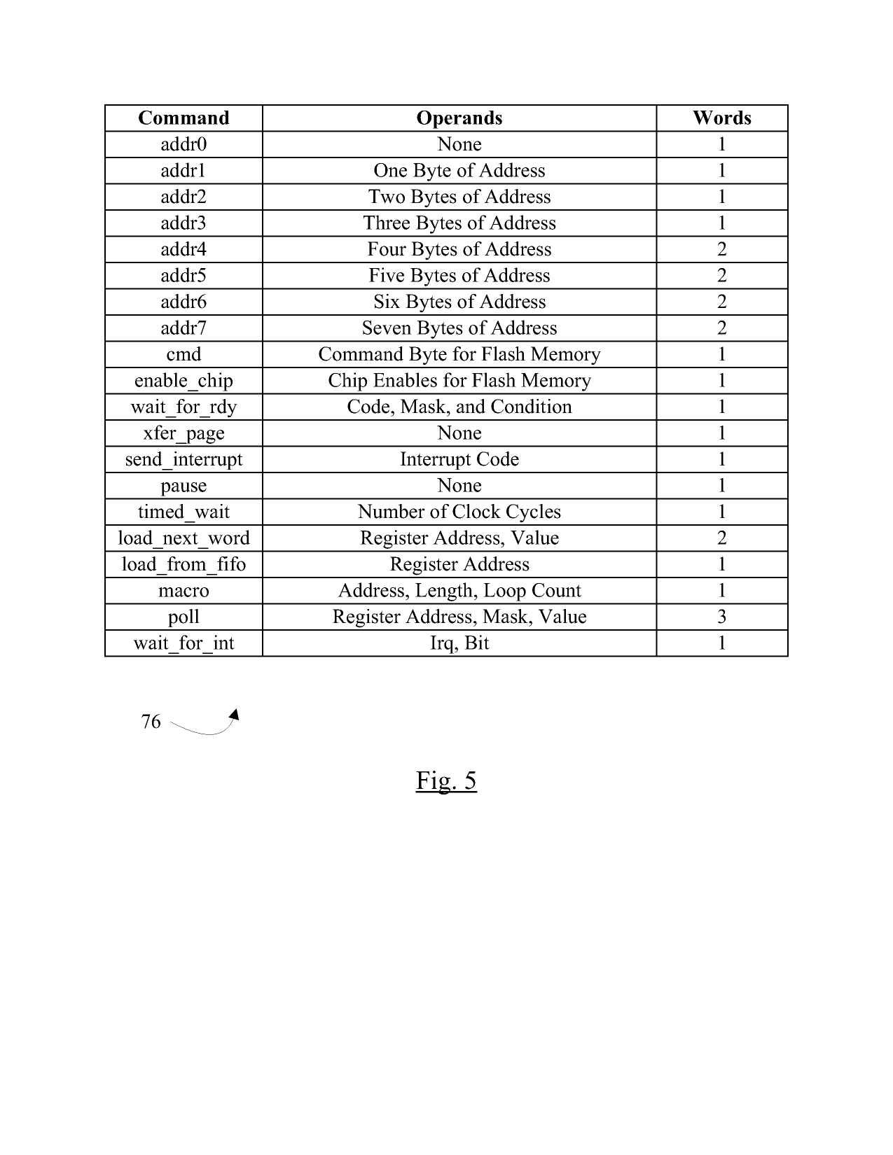

Turning next to FIG. 5, a table 76 is shown illustrating an exemplary command set that may be supported by one embodiment of the flash memory interface unit 30, and more particularly the FMI control circuit 42. Other embodiments may support any other set of commands, including subsets of the commands shown in FIG. 4, subsets of the commands and other commands, and/or a superset of the commands and other commands. The table includes a “command” column listing each command, an “operands” column indicating the operands for a given command, and a “words” column indicating the number of words in the command FIFOs 40 or 41 that are occupied by the command.

The format of the commands may vary from embodiment to embodiment. For example, in one embodiment, each command may include an opcode byte that identifies the command within the command set (that is, each entry in the table 76 may be identified via a different opcode encoding). Remaining bytes in the word or words forming the command may be used to specify operands for the command. The commands may be stored in the command FIFOs 40 or 41, or the macro memory 44, in various embodiments.

The address commands (addr0 to addr7 in table 76) may be used to issue address bytes on the interface to the flash memory devices 28A-28B (more succinctly referred to as the flash memory interface). The digit after “addr” indicates the number of address bytes transmitted, starting with byte 0 of the address on the flash memory interface. The FMI control circuit 42 may be configured to pause until the address bytes have been transmitted before performing the next command, in one embodiment. The addrX commands may be equivalent to programming the following FMC control registers 50, in one embodiment: one or more address registers with the address bytes, and programming a transfer number and read/write mode in one or more registers. Responsive to the read/write mode, the FMC 48 may transmit the address bytes on the flash memory interface and may signal an address done interrupt in a status register within the FMC control registers 50. Additionally, the addrX commands may further include waiting for and clearing and address done interrupt in the status register. The addr0 command may differ from the addr1 through addr7 commands in that the address registers and address transfer number register are not programmed. Instead these registers may be preprogrammed using other commands such as the load_next_word or load_from_fifo commands described below.

The cmd command may be used to send a flash memory interface command out on the flash memory interface. In one embodiment, flash memory interface commands are one byte. Accordingly, the operand of the cmd command may be the command byte may be transmitted on the flash memory interface. The FMI control circuit 42 may be configured to pause until the cmd command is completed on the flash memory interface. The cmd command may be equivalent to programming a command register in the FMC control registers 50 with the command byte; setting a command mode bit in another FMC control register 50; and waiting for and clearing a cmd done interrupt in a status register within the FMC control registers 50. Responsive to the setting of the command mode bit, the FMC 48 may be configured to transmit the command byte on the flash memory interface and may write the cmd done interrupt to the status register.

The enable_chip command may be used to write a chip enable register of the FMC control registers 50, which may cause the FMC 48 to drive chip enable signals on the flash memory interface based on the chip enable operand.

The xfer_page command may be used to initiate a page transfer to/from the flash memory devices 28A-28B. In response to the xfer_page command, the FMI control circuit 42 may be configured to set a start bit in an FMC control register 50 and wait for and clear a page done interrupt bit in another FMC control register 50. In response to the start bit, the FMC 48 may be configured to perform the specified page transfer, and set the page done interrupt upon completion.

There may be various synchronizing command supported by the FMI control circuit 42. Generally, a synchronizing command may be used to specify an event that the FMI control circuit 42 is to monitor for, and may cause the FMI control circuit 42 to wait for the event to occur (i.e. wait until the FMI control circuit 42 detects the event) prior to performing the next command. Thus, synchronizing commands may permit sequences of commands to be preprogrammed, and the synchronizing commands may help ensure the correct timing. For example, multiple page transfers may be preprogrammed, and synchronizing commands may be used to delay programming of the FMC control registers 50 for the next page until the registers are no longer needed for the current page (e.g. after the last data from the page is loaded into the buffer 52A-52B for a read).

In the embodiment of FIG. 4, the synchronizing commands may include wait_for_rdy, pause, timed_wait, and wait_for_int. The wait_for_rdy command may be used to monitor the status of the flash memory devices 28A-28B during a page transfer. The wait_for_rdy command may include waiting for and clearing a specific “done” interrupt (e.g. page done) in the status register of the FMC control registers 50; masking a status byte in the status register with the mask operand, and comparing the masked status byte to the condition operand. If the masked status byte matches the condition operand, the FMI control circuit 42 may be configured to perform the next command. Otherwise, the FMI control circuit 42 may signal an interrupt (e.g. to the IOP 32 or the processor 22, in various embodiments) and may stop performing additional commands until the IOP 32/processor 22 services the interrupt.

The pause command may be used to pause command performance by the FMI control circuit 42. The FMI control circuit 42 may cease performing commands until specifically unpaused by software executing on the IOP 32/processor 22 writing a specified enable bit in one of the FMC control registers 50.

The FMI control circuit 42 may be configured to pause and resume after a number of clock cycles via the timed_wait command. The number of clock cycles is specified as the operand of the timed_wait command. In some embodiments, the timed_wait command may be used to slow down the flash memory interface unit 30, because the performance possible using the command FIFO 40, the macro memory 44, and the operand FIFO 46 may exceed the rate at which activities may be performed by the flash memory devices 28A-28B.

The wait_for_int command may be used to cause the FMI control circuit 42 to wait for a specified interrupt value. The operands may specify the interrupt (irq) to be waited on, and the state of the irq bit to be waited on (e.g. set or clear), using the “bit” operand.

The send_interrupt command may be used to send a specified interrupt to the IOP 32 or processor 22. The operand of the send_interrupt command may specify an interrupt code to write into an interrupt code register of the FMC control registers 50, which may cause the interrupt to be sent.

The load_next_word and load_from_fifo commands may be used to program various registers in the FMC control registers 50. One of the operands of these commands is the register address of the control register to be written. In response to the load_next_word command, the FMI control circuit 42 may read the next word from the command FIFO 40 and write the word to the addressed register. In response to the load_from_fifo command, the FMI control circuit 42 may be configured to read the word at the head of the operand FIFO 46 and write the word to the addressed register.

The macro command may be used to cause the FMI control circuit 42 to read commands from the macro memory 44. The macro command includes an address operand, a length operand, and a loop count operand. The address may identify the first word to be read from the macro memory 44, and the length may identify the length of the macro (e.g. in terms of number of commands or number of words). In one embodiment, the length is the number of words. The loop count may indicate a number of iterations of the macro to be performed. In one embodiment, the loop count operand may be one less than the number of iterations (e.g. a loop count of zero is one iteration, a loop count of one is two iterations, etc.). Once a macro completes the next command FIFO 42 may be read (i.e. there may be no return command in the macro).

The poll command may be to poll any register in the FMC control registers 50 for a specified value (after masking the value read from the register using the mask field). The FMI control circuit 42 may poll the register until the specified value is detected, then proceed to the next command.

As noted in the above description, the FMI control circuit 42 may monitor for various interrupts recorded in one or more status registers within the FMC control registers 50 as part of performing certain commands. The FMI control circuit 42 may clear the interrupt and complete the corresponding command. In the absence of commands in the command FIFO 40, the interrupts may instead be forwarded to the IOP 32/processor 22 (if enabled). Accordingly, PIO write operations to the FMC control registers 50 and interrupts to the IOP 32/processor 22 may be another mechanism to perform memory transfers to/from the flash memory devices 28A-28B.

In an embodiment, the commands that may be long-latency and abortable may include the synchronizing commands that wait for a specified event (e.g. wait_for_int, timed_wait, and wait_for_rdy) and the poll command. To the extent that such commands include a communication on the interface to the flash memory devices 28A-28B, the abort of the commands may include terminating the communication according to the protocol requirements and/or electrical requirements of the interface. These commands may be initiated, but then aborted prior to completion (e.g. prior to receiving the ready on the interface for the wait_for_rdy command, prior to detecting the desired interrupt for with wait_for_int command, prior to the expiration of the time interval for the timed_wait command, and prior to detecting the polled-for value for the poll command).

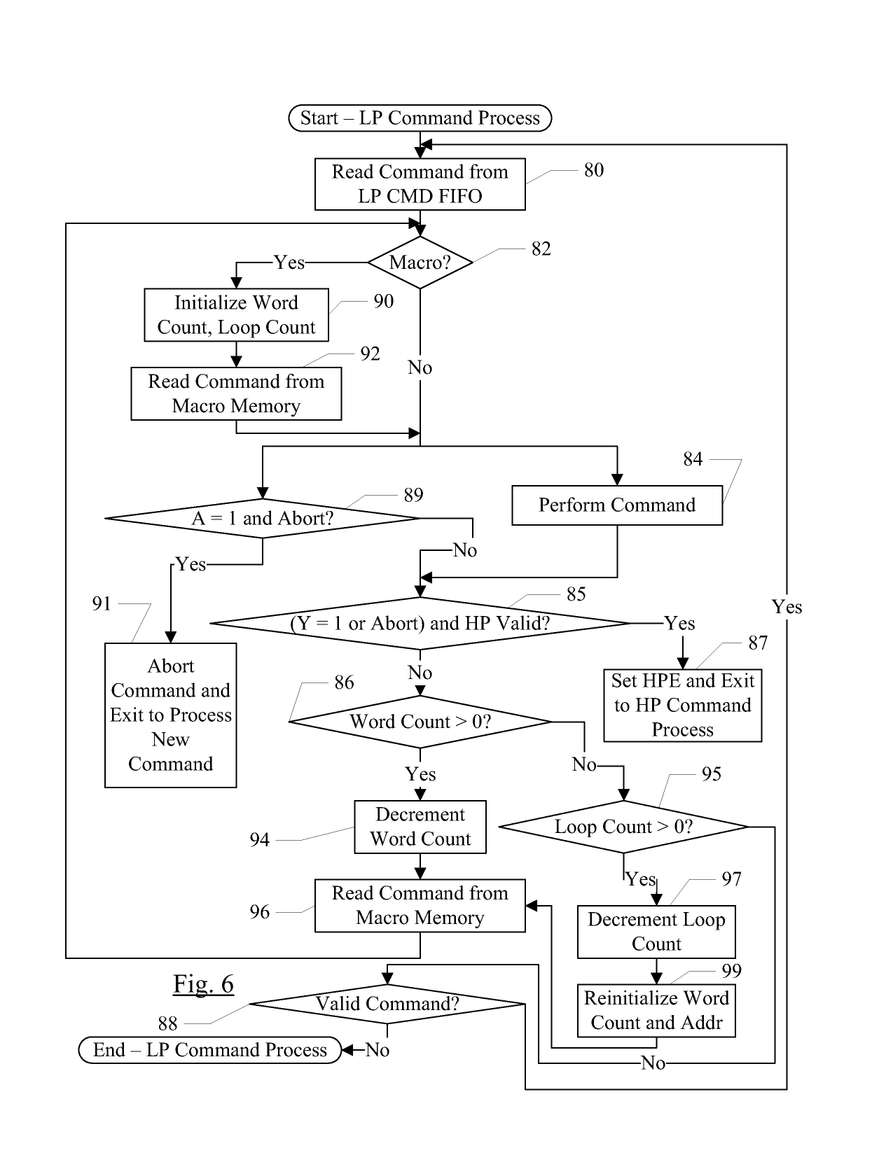

Turning now to FIG. 6, a flowchart is shown illustrating operation of one embodiment of the FMI control circuit 42 to process a command from the LP command queue 40. The flowchart of FIG. 6 may also be applicable to the embodiment of FIG. 2, except that blocks 85 and 87 may be eliminated. While the blocks are shown in a particular order for ease of understanding, other orders may be used. Blocks may be performed in parallel in combinatorial logic in the FMI control circuit 42. Blocks, combinations of blocks, and/or the flowchart as a whole may be pipelined over multiple clock cycles. The FMI control circuit 42 may be configured to implement the operation illustrated in FIG. 6.

The FMI control circuit 42 may be configured to read a command from the LP command FIFO 40 (block 80). If the command is not a macro command (decision block 82, “no” leg), the FMI control circuit 42 may be configured to perform the command (block 84). In parallel with performing the command, the FMI control circuit 42 may be configured to monitor for an abort request. If an abort request is received and the abort indication for the command is set (decision block 89, “yes” leg), the FMI control circuit 42 may be configured to abort the command and exit to process the new high priority command (block 91). The exit may be to the HP command processing (e.g. to FIG. 7) or may be to process a command in the direct execution register. Once the command completes, and if the yield (Y) bit is set and there is a valid command in the HP command queue 41, or if there is an abort request (decision block 85, “yes” leg), the FMI control circuit 42 may be configured to set the HPE bit in the register 51 and exit to the HP command processing (e.g. to FIG. 7) (block 87). Similarly, in some embodiments, the FMI control circuit 42 may be configured to exit to the HP command processing (or at least to cease low priority processing) responsive to the HPE bit being set (e.g. by software writing the register 51). Otherwise (decision block 84, “no” leg), the FMI control circuit 42 may be configured to check a word count used to determine if a macro has reached its end. If the command is not part of a macro, the word count may be zero (decision block 86, “no” leg). The FMI control circuit 42 may be configured to check the loop count associated with the macro command. If the command is not part of a macro, the loop count may be zero (decision block 95, “no” leg). The FMI control circuit 42 may be configured to determine if there is another valid command in the command FIFO 40 (decision block 88). That is, the FMI control circuit 42 may be configured to determine if the command FIFO 40 is empty. If there is another valid command (decision block 88, “yes” leg), the FMI control circuit 42 may be configured to read and process the next command. Otherwise, the FMI control circuit 42's command processing circuitry may be idle until another valid command is written to the command FIFO 40 (decision block 88, “no” leg).

If the command is a macro command (decision block 82, “yes” leg), the FMI control circuit 42 may be configured to initialize the word count to the length operand of the macro command and to initialize the loop count to the loop count operand of the macro command (block 90). The FMI control circuit 42 may also read a command from the macro memory 44 (block 92). Specifically, in this case, the FMI control circuit 42 may read the first word from the address in the macro memory 44 provided as the address operand of the macro command. The FMI control circuit 42 may be configured to perform the command (block 84) and to monitor for an abort request in parallel (decision block 89). The FMI control circuit 42 may be configured to check the word count (in this case there may be no Y bit and thus the decision block 85 may result in the “no” leg). The word count may be greater than zero (decision block 86, “yes” leg), and the FMI control circuit 42 may be configured to decrement the word count and to read the next command from the macro memory 44 (e.g. by incrementing the address) (blocks 94 and 96). The FMI control circuit 42 may be configured to process the next command (returning to decision block 82 in the flowchart of FIG. 6). If the word count is zero (decision block 86, “no” leg), the FMI control circuit 42 may be configured to check the loop count. If the loop count is greater than zero (decision block 95, “yes” leg), another iteration of the macro is to be performed. The FMI control circuit 42 may decrement the loop count (block 97), reinitialize the word count and the macro address (block 99), and read the next command from the macro memory 44 (i.e. the first command of the macro) (block 96). If both the word count and loop count are zero (decision block 86 and 5, “no” legs), the macro is complete and the FMI control circuit 42 may check for the next valid command in the command queue 40 (decision block 88).

It is noted that, since each command is checked for being a macro command, macro commands may be stored in the macro memory 44 as well. Accordingly, macros may be “nested”, although the last macro to be performed returns to the command FIFO 40 so there isn't true nesting in the sense that macros do not return to macros that called them.

FIG. 7 is a flowchart illustrating operation of one embodiment of the FMI control circuit 42 to process a command from the HP command queue 41. That is, processing as illustrated in FIG. 7 may be initiated in response to exiting the LP processing as discussed above with regard to FIG. 5 (block 87 or, in some embodiments, block 91). While the blocks are shown in a particular order for ease of understanding, other orders may be used. Blocks may be performed in parallel in combinatorial logic in the FMI control circuit 42. Blocks, combinations of blocks, and/or the flowchart as a whole may be pipelined over multiple clock cycles. The FMI control circuit 42 may be configured to implement the operation illustrated in FIG. 7.

The FMI control circuit 42 may be configured to read a command from the HP command FIFO 40 (block 180). If the command is not a macro command (decision block 182, “no” leg), the FMI control circuit 42 may be configured to perform the command (block 184). Once the command completes, the FMI control circuit 42 may be configured to check a word count used to determine if a macro has reached its end. If the command is not part of a macro, the word count may be zero (decision block 186, “no” leg). The FMI control circuit 42 may be configured to check the loop count associated with the macro command. If the command is not part of a macro, the loop count may be zero (decision block 195, “no” leg). The FMI control circuit 42 may be configured to determine if there is another valid command in the HP command FIFO 41 (decision block 188). That is, the FMI control circuit 42 may be configured to determine if the HP command FIFO 41 is empty. If there is another valid command (decision block 188, “yes” leg), the FMI control circuit 42 may be configured to read and process the next command. Otherwise, the FMI control circuit 42 may check if the HPE bit is clear (decision block 198). If so, the FMI control circuit 42 my return to LP command processing (decision block 198, “yes” leg). If not (decision block 198, “no” leg), the FMI control circuit 42 may be idle until either a valid command appears in the HP command FIFO 41 or the HPE bit is cleared.

If the command is a macro command (decision block 182, “yes” leg), the FMI control circuit 42 may be configured to initialize the word count to the length operand of the macro command and to initialize the loop count to the loop count operand of the macro command (block 190). The FMI control circuit 42 may also read a command from the macro memory 44 (block 192). Specifically, in this case, the FMI control circuit 42 may read the first word from the address in the macro memory 44 provided as the address operand of the macro command. The FMI control circuit 42 may be configured to perform the command (block 184), and may be configured to check the word count. The word count may be greater than zero (decision block 186, “yes” leg), and the FMI control circuit 42 may be configured to decrement the word count and to read the next command from the macro memory 44 (e.g. by incrementing the address) (blocks 194 and 196). The FMI control circuit 42 may be configured to process the next command (returning to decision block 182 in the flowchart of FIG. 7). If the word count is zero (decision block 186, “no” leg), the FMI control circuit 42 may be configured to check the loop count. If the loop count is greater than zero (decision block 195, “yes” leg), another iteration of the macro is to be performed. The FMI control circuit 42 may decrement the loop count (block 197), reinitialize the word count and the macro address (block 199), and read the next command from the macro memory 44 (i.e. the first command of the macro) (block 196). If both the word count and loop count are zero (decision block 186 and 195, “no” legs), the macro is complete and the FMI control circuit 42 may check for the next valid command in the HP command FIFO 41 (decision block 188).

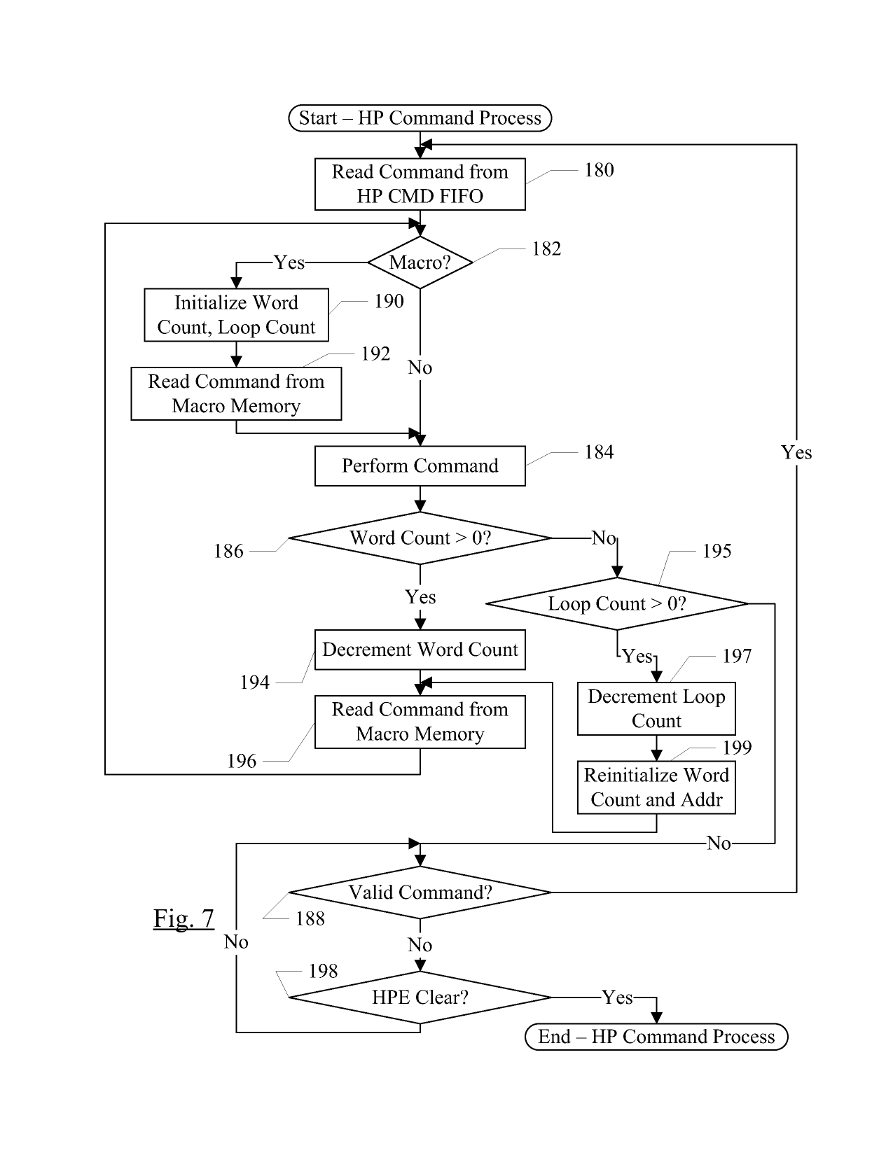

Turning now to FIG. 8, a block diagram of an example of a use of macros to perform a multiple page write to a flash memory device 28A or 28B is shown. A contents of the macro memory 44 is shown, including three sections of commands. Between macro memory address 0 and N−1, N words of macro 100 to complete a write to the previous page are stored. Between macro memory address N and N+M−1, M words of macro 102 to start a write to a next page are stored. Between macro memory address N+M and N+M+P−1, P words of macro 104 are stored to finish a last page of a write to memory.

A set of commands in the LP command FIFO 40 are illustrated in FIG. 8, with a head of the FIFO at the top of the LP command FIFO 40 and the subsequent commands in the FIFO proceeding in order down the LP command FIFO 40 as illustrated in FIG. 8. The first command is macro N, M. The command calls the macro 104, beginning at word N, and performs M words (i.e. the macro 102 as illustrated in FIG. 6). Thus, the write to the first page is initialized. Subsequent page writes may be performed using the macro 0, N+M commands. These commands cause the macro 100 and the macro 102 to be performed. The write to the previous page may be completed (macro 100) and the write to the next page may be started (macro 102). The last page may be written using the macro 0, N+M+P command. This command causes the macros 100, 102, and 104 to be performed, completing the write to the second to last page (macro 100), performing the write to the last page (macro 102), and completing the write to the last page and closing the flash memory device 28A or 28B (macro 104). In this example, the loop count operand of each macro command is zero (one iteration). However, in another example, shown below the first example in FIG. 8, the loop count operand may be used to make the commands in the command queue even more efficient. The loop count of the macro N, M command for the first page and the macro 0, N+M+P command for the last page may still be zero, specifying one iteration. However, the middle pages of the write may all be accomplished using one macro command (macro 0, N+M) with a loop count operand equal to the page count (C) minus 3. The loop count is C−3 to account for the first and last page, as well as the fact that the loop count operand is one less than the desired number of iterations in this embodiment. As the macros 100, 102, and 104 illustrate, through careful arrangement of the macros in the macro memory 44, dense and efficient macros may result. The macros may employ load_from_fifo commands to use different operands for each page write operand, and the operands for each page may be loaded into the operand FIFO 46 prior to initiating the commands in the LP command FIFO 40.

The commands included in the macro 102 may establish the address to be written, chip enables, etc. The commands included in the macro 100 may include xfer_page to transfer the previous page to the memory, and commands to check for errors and synchronize the next page transfer (which may be initialized via the macro 102). The macro 104 may include the final xfer_page command, as well as commands to check for errors and to close the flash memory device that was the target of the writes, deactivating the active page/region and/or performing any other operations as specified for the flash memory device.

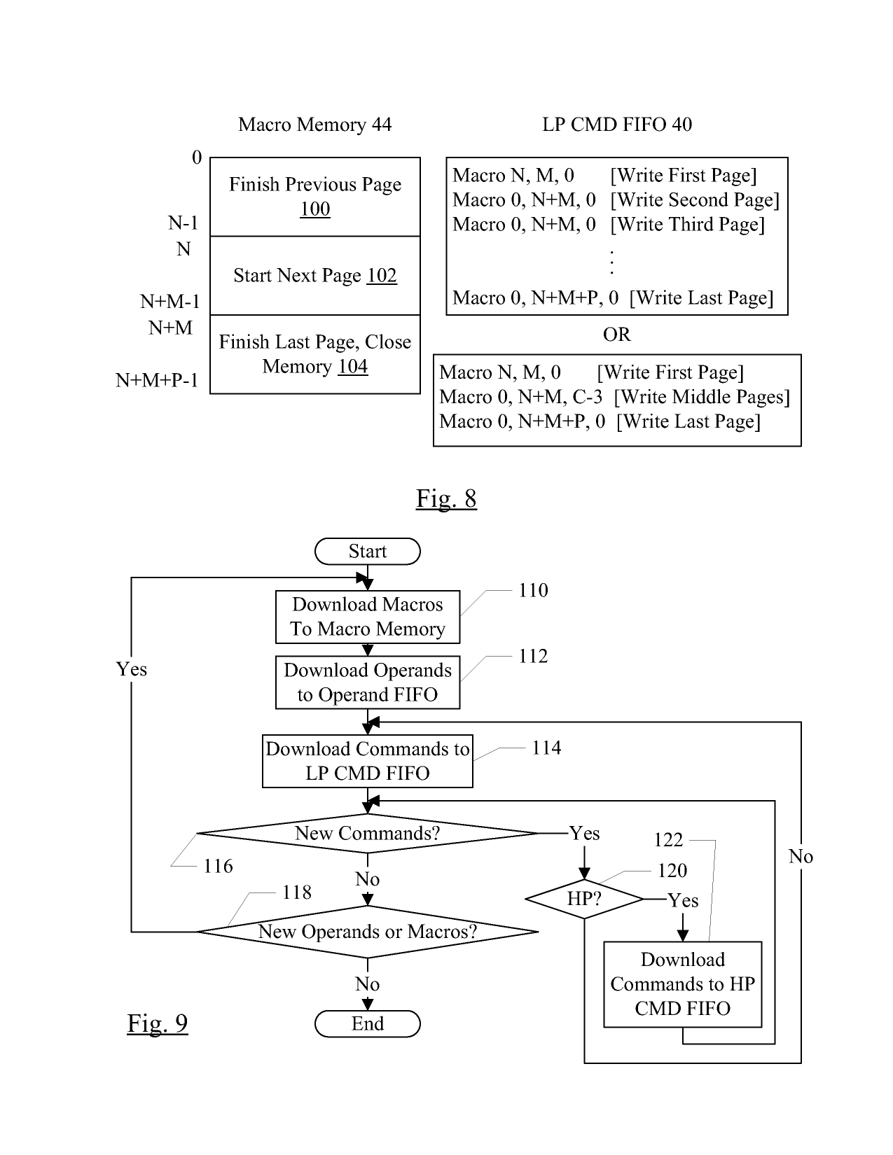

Turning now to FIG. 9, a flowchart illustrating operation of a flash code to be executed by the IOP 32 and/or the processor 22 is shown. While the blocks are shown in a particular order for ease of understanding, other orders may be used. The flash code may include instructions which, when executed by the IOP 32 and/or the processor 22, may implement the operation illustrated in FIG. 9.

The flash code may be executed at any time during operation of the integrated circuit 10. For example, the flash code may be executed to initialize the flash memory interface unit 30. The flash code may also be executed at any time that the flash memory 30 has been idle but is to be accessed, to reconfigure the macros in the macro memory 44, etc.

The flash code may download any desired macros to the macro memory 44 (block 110). If the macros already stored in the macro memory 44 are the desired macros, or if there are no desired macros, block 110 may be skipped. The flash code may also download any operands to be used by the commands or the macros (block 112), and block 112 may be skipped if there are no operands to be downloaded. The flash code may download the commands to be performed to the LP command FIFO 40 (block 114), and command performance may begin in the flash memory interface unit 30. Downloading the commands to the LP command FIFO 50 may include setting the Y bits and/or A bits for various commands, such that abort and interruption of the commands for high priority commands is permissible. Other Y bits and A bits may be cleared. If additional commands are ready to be downloaded (decision block 116, “yes” leg), and those commands are higher priority than the commands currently being performed by the flash memory interface unit 30 (decision block 120, “yes” leg), the flash code may download the additional commands to the HP command FIFO 41 (block 122). Additionally, if desired, the abort request may be communicated by writing the abort field in the register 51. Otherwise (decision block 120, “no” leg), the flash code may download the commands to the LP command FIFO 40 (block 114). If new operands or macros are ready to be downloaded (decision block 118, “yes” leg), the flash code may return to blocks 110 and/or 112 to download them. Additionally, upon completion of the HP commands, the flash code may reset the HPE bit and/or the abort request in the register 51 (not shown in FIG. 9).

### System and Computer Accessible Storage Medium

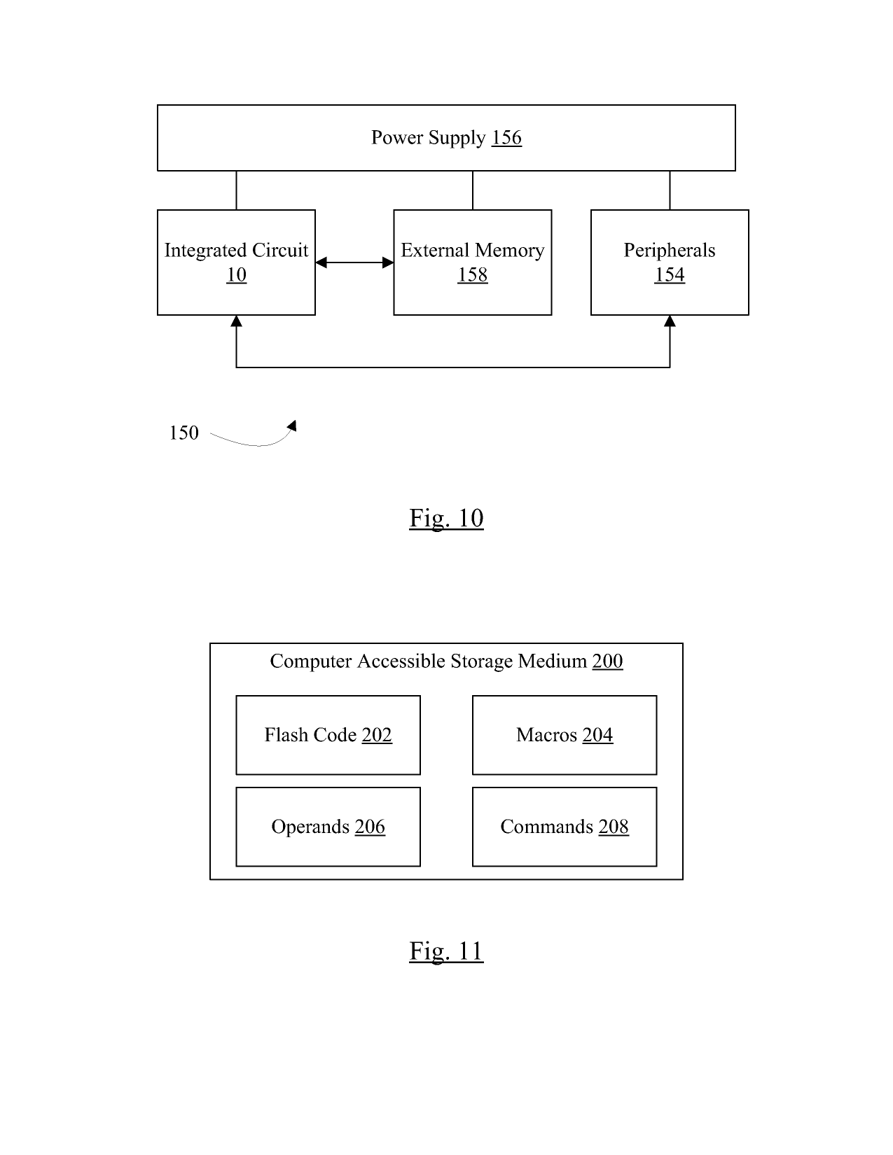

Turning next to FIG. 10, a block diagram of one embodiment of a system 150 is shown. In the illustrated embodiment, the system 150 includes at least one instance of an integrated circuit 10 (from FIG. 1) coupled to one or more peripherals 154 and an external memory 158. The external memory 158 may include the memory 12 and/or the flash memory 28A-28B. A power supply 156 is also provided which supplies the supply voltages to the integrated circuit 10 as well as one or more supply voltages to the memory 158 and/or the peripherals 154. In some embodiments, more than one instance of the integrated circuit 10 may be included (and more than one external memory 158 may be included as well).

The peripherals 154 may include any desired circuitry, depending on the type of system 150. For example, in one embodiment, the system 150 may be a mobile device (e.g. personal digital assistant (PDA), smart phone, etc.) and the peripherals 154 may include devices for various types of wireless communication, such as wifi, Bluetooth, cellular, global positioning system, etc. The peripherals 154 may also include additional storage, including RAM storage, solid state storage, or disk storage. The peripherals 154 may include user interface devices such as a display screen, including touch display screens or multitouch display screens, keyboard or other input devices, microphones, speakers, etc. In other embodiments, the system 150 may be any type of computing system (e.g. desktop personal computer, laptop, workstation, net top etc.).

The external memory 158 may include any type of memory. For example, the external memory 158 may be SRAM, dynamic RAM (DRAM) such as synchronous DRAM (SDRAM), double data rate (DDR, DDR2, DDR3, etc.) SDRAM, RAMBUS DRAM, etc. The external memory 158 may include one or more memory modules to which the memory devices are mounted, such as single inline memory modules (SIMMs), dual inline memory modules (DIMM5), etc.

Turning now to FIG. 11, a block diagram of a computer accessible storage medium 200 is shown. Generally speaking, a computer accessible storage medium may include any storage media accessible by a computer during use to provide instructions and/or data to the computer. For example, a computer accessible storage medium may include storage media such as magnetic or optical media, e.g., disk (fixed or removable), tape, CD-ROM, DVD-ROM, CD-R, CD-RW, DVD-R, DVD-RW, or Blu-Ray. Storage media may further include volatile or non-volatile memory media such as RAM (e.g. synchronous dynamic RAM (SDRAM), Rambus DRAM (RDRAM), static RAM (SRAM), etc.), ROM, Flash memory, non-volatile memory (e.g. Flash memory) accessible via a peripheral interface such as the Universal Serial Bus (USB) interface, a flash memory interface (FMI), a serial peripheral interface (SPI), etc. Storage media may include microelectromechanical systems (MEMS). All of the above storage media may be non-transitory storage media. The computer accessible storage medium 200 in FIG. 11 may store flash code 202, which may include code executable by the IOP 32 and/or the processor 22. The flash code 202 may include instructions which, when executed, implement the operation described above with regard to FIG. 9. Generally, the computer accessible storage medium 200 may store any set of instructions which, when executed, implement a portion or all of the operation shown in FIG. 9. Furthermore, the computer accessible storage medium 200 may store one or more macros 204 to be downloaded to the macro memory 44, one or more operands to be downloaded to the operand FIFO 36, and/or one or more commands to be downloaded to the command FIFO 40. A carrier medium may include computer accessible storage media as well as transmission media such as wired or wireless transmission.

Numerous variations and modifications will become apparent to those skilled in the art once the above disclosure is fully appreciated. It is intended that the following claims be interpreted to embrace all such variations and modifications.

What is claimed is:

1. An apparatus to control an external interface in an integrated circuit, the apparatus comprising:
a first command queue configured to store a plurality of first commands, wherein the first command queue is further configured to store a plurality of first indications, wherein each first indication of the plurality of first indications corresponds to a respective first command of the plurality of first commands, and wherein the first indication indicates whether or not the respective first command is abortable; and
a control circuit coupled to the first command queue, wherein the control circuit is configured to detect that a high priority command separate from the first command queue is to be processed, and wherein the control circuit is configured to abort processing of a given first command that is being processed in response to detecting that the high priority command is to be processed and further in response to a corresponding first indication indicating that the given first command is abortable.

2. The apparatus as recited in claim 1 wherein the control circuit is configured not to abort the given first command responsive to the corresponding first indication indicating that the given first command is not abortable.

3. The apparatus as recited in claim 2 wherein the control circuit is configured to interrupt processing of the plurality of first commands subsequent to completing the given first command to process the high priority command responsive to the corresponding first indication indicating that the given first command is not abortable.

4. The apparatus as recited in claim 1 further comprising a first control register coupled to the control circuit, wherein the control circuit is configured to detect the high priority command responsive to an update to a first field in the first control register.

5. The apparatus as recited in claim 4 further comprising a second control register coupled to the control circuit, wherein the high priority command is stored in the second control register.

6. The apparatus as recited in claim 4 further comprising a second command queue coupled to the control circuit and configured to store a second plurality of commands including the high priority command.

7. The apparatus as recited in claim 6 wherein the first command queue is further configured to store a plurality of second indications, wherein each second indication of the plurality of second indications corresponds to the respective first command of the plurality of first commands and indicates whether or not the plurality of first commands is interruptible at completion of the respective first command, and wherein the control circuit is configured to interrupt the plurality of first commands subsequent to completion of the plurality of first commands and responsive to the respective second indication indicating interruptible.

8. A method comprising:
processing commands from a first queue in a flash memory controller to perform one or more transfers with a flash memory to which the memory controller is coupled;
during processing of a first command from the first queue, detecting a high priority command; and
aborting processing of the first command prior to completion of the first command, wherein the first command is defined to wait for a specified event; and
processing the high priority command responsive to the aborting.

9. The method as recited in claim 8 wherein the specified event is an interrupt.

10. The method as recited in claim 8 wherein the specified event is expiration of a predefined time interval.

11. The method as recited in claim 8 wherein the specified event is a ready indication from the flash memory to which the flash memory controller is coupled.

12. The method as recited in claim 8 further comprising:
during processing of a poll command from the first queue, detecting a second high priority command; and
aborting processing of the poll command prior to completion of the poll command; and
processing the second high priority command responsive to the aborting of the poll command.

13. The method as recited in claim 8 wherein the detecting the high priority command is responsive to an update of a field in a control register in the flash memory controller.

14. An integrated circuit comprising:
a memory controller configured to couple to one or more memory devices;
a flash memory interface unit configured to coupled to one or more flash memory devices;
a direct memory access (DMA) controller coupled to the memory controller and the flash memory interface unit, wherein the DMA controller is configured to perform DMA operations between the memory controller and the flash memory interface unit; and
a processor coupled to the DMA controller, wherein the processor is configured to control the flash memory interface unit, and wherein communications from the processor pass through the DMA controller to the flash memory unit over an interconnect between the DMA controller and the flash memory interface, and wherein the interconnect is also used in the DMA operations between the flash memory interface unit and the memory controller;
wherein the flash memory interface unit comprises a command queue, and wherein the processor is configured to write a first plurality of commands to the command queue to control a first transfer between the flash memory interface and the one or more flash memory devices, and wherein the processor is configured to determine that a high priority command is to be performed by the flash memory interface unit, and wherein the processor is configured to write a control register in the flash memory interface unit to cause the flash memory interface unit to terminate processing a first command of the first plurality of commands while the first command is in progress and has not completed in response to determining that the high priority command is to be processed.

15. The integrated circuit as recited in claim 14 wherein the first command is defined to wait for a specified event, and wherein the termination occurs prior to the specified event occurring.

16. The integrated circuit as recited in claim 14 wherein the first command is a wait for ready command defined to wait for a ready indication from the one or more flash memory devices, and wherein terminating the wait for read indication includes terminating the command on an interface to the one or more flash memory devices.

17. The integrated circuit as recited in claim 14 wherein the first command is a poll command defined to poll for a specified value in a control register in the flash memory interface unit, and wherein the first command is terminated prior to detecting the specified value.

18. The integrated circuit as recited in claim 14 wherein the first command is a timed wait command that is defined to wait for expiration of a time interval, and wherein the first command is terminated prior to the expiration of the time interval.

19. The integrated circuit as recited in claim 14 wherein the first command is a wait for interrupt command defined to wait for an interrupt, and wherein the first command is terminated prior to the interrupt.

20. A computer readable storage medium storing a plurality of instructions which, when executed on an processor in an integrated circuit that also includes a memory interface unit that comprises a command queue, wherein the command queue is configured to store a plurality of commands to control a memory controller coupled to an external memory interface:
load a first plurality of commands into the command queue, wherein performance of the first plurality of commands causes a first transfer between one or more memory devices coupled to the external interface and the integrated circuit;
detect a need for a high priority command; and
communicate an abort request to abort a first command in the first plurality of commands to perform the high priority command.

21. The computer readable storage medium as recited in claim 20 wherein the plurality of instructions which, when executed, load the first plurality of include instructions which, when executed, load corresponding indications of which of the first plurality of commands are abortable.

22. The computer readable storage medium as recited in claim 20 wherein the plurality of instructions which, when executed, communicate the abort request including one or more instructions which write a control register in the memory interface unit.

23. The computer readable storage medium as recited in claim 22 wherein the plurality of instructions, when executed, write the high priority command to a second control register in the memory interface unit.

24. The computer readable storage medium as recited in claim 22 wherein the plurality of instructions, when executed, write the high priority command to a second command queue in the memory interface unit.
